(19) United States
(12) Patent Application Publication
(10) Pub. No.: US 2024/0381426 A1
(43) Pub. Date: Nov. 14, 2024

(54) DEMODULATION REFERENCE SIGNAL (DM-RS) PATTERNS AND SCRAMBLING SEQUENCES FOR PHYSICAL SIDELINK CONTROL CHANNEL (PSCCH) OR PHYSICAL SIDELINK SHARED CHANNEL (PSSCH) TRANSMISSIONS WITH MULTIPLE STARTING SYMBOLS

(71) Applicant: QUALCOMM Incorporated, San Diego, CA (US)

(72) Inventors: Chih-Hao LIU, San Diego, CA (US); Giovanni CHISCI, San Diego, CA (US); Jing SUN, San Diego, CA (US); Xiaoxia ZHANG, San Diego, CA (US)

(21) Appl. No.: 18/636,029

(22) Filed: Apr. 15, 2024

Related U.S. Application Data
(60) Provisional application No. 63/466,215, filed on May 12, 2023.

(51) Int. Cl. H04W 74/0816; H04L 5/00; H04W 52/52; H04W 72/25; H04W 74/08

(52) U.S. Cl. CPC H04W 74/0816; H04L 5/0051; H04W 52/52; H04W 72/25; H04W 74/0866

(57) ABSTRACT

A method for wireless communication at a first user equipment (UE) includes performing, in a shared radio frequency band, a listen-before-talk (LBT) procedure for a channel occupancy time (COT). The method also includes selecting a first or second starting symbol for an initial slot based on a timing associated with the LBT procedure indicating a clearance, the initial slot having a first or second total number of symbols in accordance with selecting the first starting symbol or the second starting symbol. The method further includes selecting either a first or second demodulation reference signal (DM-RS) pattern from a group of DM-RS patterns in accordance with the initial slot having the first total number of symbols or the initial slot having the second total number of symbols. The method also includes transmitting, during the COT, sidelink information to a second UE via a sequence of slots that include the initial slot.

### CROSS-REFERENCE TO RELATED APPLICATION

The present application claims the benefit of U.S. Provisional Patent Application No. 63/466,215, filed on May 12, 2023, and titled “DEMODULATION REFERENCE SIGNAL (DMRS) PATTERNS AND SCRAMBLING SEQUENCE FOR PHYSICAL SIDELINK CONTROL CHANNEL (PSCCH) OR PHYSICAL SIDELINK SHARED CHANNEL (PSSCH) TRANSMISSIONS WITH MULTIPLE STARTING SYMBOLS,” the disclosure of which is expressly incorporated by reference in its entirety.

### TECHNICAL FIELD

This application relates to wireless communication systems, and more particularly to demodulation reference signal (DM-RS) patterns and scrambling sequences for physical sidelink control channel (PSCCH) or physical sidelink shared channel (PSSCH) transmissions in a slot associated with multiple starting symbols.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5th Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from a licensed spectrum to an unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology had been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed bands and/or unlicensed bands.

### SUMMARY

In some aspects of the present disclosure, a method for wireless communication at a first user equipment (UE) includes performing, in a shared radio frequency band, a look listen-before-talk (LBT) procedure for a channel occupancy time (COT). The method further includes selecting a first starting symbol or a second starting symbol for an initial slot based on a timing associated with the LBT procedure indicating a clearance, the initial slot having a first total number of symbols in accordance with selecting the first starting symbol and a second total number of symbols in accordance with selecting the second starting symbol. The method also includes selecting either a first demodulation reference signal (DM-RS) pattern from a group of DM-RS patterns in accordance with the initial slot having the first total number of symbols or a second DM-RS pattern from the group of DM-RS patterns in accordance with the initial slot having the second total number of symbols. The method further includes transmitting, during the COT, sidelink information to a second UE via a sequence of slots, the sequence of slots including the initial slot.

Other aspects of the present disclosure are directed to an apparatus. The apparatus includes means for performing, in a shared radio frequency band, an LBT procedure for a COT. The apparatus further includes means for selecting a first starting symbol or a second starting symbol for an initial slot based on a timing associated with the LBT procedure indicating a clearance, the initial slot having a first total number of symbols in accordance with selecting the first starting symbol and a second total number of symbols in accordance with selecting the second starting symbol. The apparatus also includes means for selecting either a first DM-RS pattern from a group of DM-RS patterns in accordance with the initial slot having the first total number of symbols or a second DM-RS pattern from the group of DM-RS patterns in accordance with the initial slot having the second total number of symbols. The apparatus still further includes means for transmitting, during the COT, sidelink information to a second UE via a sequence of slots, the sequence of slots including the initial slot.

In other aspects of the present disclosure, a non-transitory computer-readable medium with program code recorded thereon is disclosed. The program code is executed by one or more processors and includes program code to perform, in a shared radio frequency band, an LBT procedure for a COT. The program code further includes program code to select a first starting symbol or a second starting symbol for an initial slot based on a timing associated with the LBT procedure indicating a clearance, the initial slot having a first total number of symbols in accordance with selecting the first starting symbol and a second total number of symbols in accordance with selecting the second starting symbol. The program code also includes program code to select either a first DM-RS pattern from a group of DM-RS patterns in accordance with the initial slot having the first total number of symbols or a second DM-RS pattern from the group of DM-RS patterns in accordance with the initial slot having the second total number of symbols. The program code further includes program code to transmit, during the COT, sidelink information to a second UE via a sequence of slots, the sequence of slots including the initial slot.

Other aspects of the present disclosure are directed to an apparatus. The apparatus includes one or more processors, and one or more memories coupled with the one or more processors and storing processor-executable code that, when executed by the one or more processors, is configured to cause the apparatus to perform, in a shared radio frequency band, an LBT procedure for a COT. Execution of the processor-executable code also causes the apparatus to select a first starting symbol or a second starting symbol for an initial slot based on a timing associated with the LBT procedure indicating a clearance, the initial slot having a first total number of symbols in accordance with selecting the first starting symbol and a second total number of symbols in accordance with selecting the second starting symbol. Execution of the processor-executable code further causes the apparatus to select either a first DM-RS pattern from a group of DM-RS patterns in accordance with the initial slot having the first total number of symbols or a second DM-RS pattern from the group of DM-RS patterns in accordance with the initial slot having the second total number of symbols. Execution of the processor-executable code still further causes the apparatus to transmit, during the COT, sidelink information to a second UE via a sequence of slots, the sequence of slots including the initial slot.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIG. 1 illustrates a wireless communication network, in accordance with various aspects of the present disclosure.

FIG. 2 illustrates a wireless communication network that provisions for sidelink communications, in accordance with various aspects of the present disclosure.

FIG. 3 illustrates reserved resources for sidelink communications, in accordance with various aspects of the present disclosure.

FIG. 4 illustrates reserved resources for sidelink communications, in accordance with various aspects of the present disclosure.

FIG. 5A is a block diagram illustrating an example of a transmitter selecting a half-slot resource pool in accordance with a listen-before-talk (LBT) clearing after a slot boundary, in accordance with various aspects of the present disclosure.

FIG. 5B is a block diagram illustrating an example of a transmitter selecting a full-slot resource pool in accordance with an LBT clearing after a slot boundary, in accordance with various aspects of the present disclosure.

FIG. 6 is a block diagram illustrating another example of an aggregated half-slot and full-slot, in accordance with various aspects of the present disclosure.

FIG. 7 is a diagram illustrating a table for allocating demodulation reference signals (DM-RSs) in a physical sidelink shared channel (PSSCH) in accordance with a number of symbols.

FIG. 8 is a diagram illustrating an example of an initial slot, in accordance with various aspects of the present disclosure.

FIG. 9 is a diagram illustrating an example of an initial slot, in accordance with various aspects of the present disclosure.

FIG. 10 is a diagram illustrating an example of dropped out-of-bounds DM-RSs, in accordance with various aspects of the present disclosure.

FIG. 11 is a flow diagram illustrating an example process performed by the user equipment (UE), in accordance with various aspects of the present disclosure.

FIG. 12 is a flow diagram illustrating an example process performed by the UE, in accordance with various aspects of the present disclosure.

### DETAILED DESCRIPTION

The detailed description set forth below in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved universal terrestrial radio access (UTRA) (E-UTRA), Institute of Electrical and Electronics Engineers (IEEE) 802.11, IEEE 802.16, IEEE 802.20, flash-OFDM, and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project, which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ultra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

A 5G NR communication system may be implemented to use optimized OFDM-based waveforms with scalable numerology and transmission time interval (TTI). Additional features may also include having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in an unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one clement of a claim.

Sidelink communications refers to the communications among user equipment devices (UEs) without tunneling through a base station (BS) and/or a core network. Sidelink communication can be communicated over a physical sidelink control channel (PSCCH) and a physical sidelink shared channel (PSSCH). The PSCCH and PSSCH are analogous to a physical downlink control channel (PDCCH) and a physical downlink shared channel (PDSCH) in downlink (DL) communication between a BS and a UE. For instance, the PSCCH may carry sidelink control information (SCI) and the PSSCH may carry sidelink data (e.g., user data). Each PSCCH is associated with a corresponding PSSCH, where SCI in a PSCCH may carry reservation and/or scheduling information for sidelink data transmission in the associated PSSCH. Use cases for sidelink communication may include V2X, enhanced mobile broadband (eMBB), industrial IoT (IIoT), and/or NR-lite.

As used herein, the term “sidelink UE” can refer to a user equipment device performing a device-to-device communication or other types of communications with another user equipment device independent of any tunneling through the BS (e.g., gNB) and/or an associated core network. As used herein, the term “sidelink transmitting UE” can refer to a user equipment device performing a sidelink transmission operation. As used herein, the term “sidelink receiving UE” can refer to a user equipment device performing a sidelink reception operation. A sidelink UE may operate as a transmitting sidelink UE at one time and as a receiving sidelink UE at another time.

In some cases, a network node, such as a base station, may configure a set of resources for use in sidelink communications between UEs, such as sidelink UEs. For example, the network node may schedule frames and/or slots for the sidelink communications. In some examples, the network node may be configured to allow the UEs to operate in a shared or unlicensed radio frequency spectrum. Prior to accessing a channel, a UE may perform a contention-based channel access procedure to gain access to the unlicensed or shared radio frequency spectrum. For example, the UE may perform a listen-before-talk (LBT) procedure (e.g., a clear channel assessment (CCA)) and determine whether signals from another device are detected on a channel or sub-channel. In the event that other signals associated with other devices are not detected, the UE may determine that the channel is available and transmit a reservation signal to indicate to other UEs that the channel is reserved for a channel occupancy time (COT).

In some cases, a UE may transmit one or more repetitions of a message to increase a likelihood of successful message reception. Such techniques may be used, for example, in cases where a message has a high priority, where the message has a low latency target and/or a high reliability, and/or where channel conditions are relatively unfavorable. In wireless communication networks that use a licensed radio frequency spectrum, the availability of a channel to transmit one or more of such repetitions may be known based on resources scheduled for UE communication. Thus, in such cases, a UE may identify a set of resources for a message and one or more sets of resources for repetitions (e.g., reservations for future resources) of the message. The message may then be transmitted using the identified resources. However, in cases where an unlicensed or shared radio frequency spectrum is used by the UE, the availability of the channel may be dependent upon a successfully completed contention-based channel access procedure (e.g., a LBT or CCA procedure).

In some cases, prior to accessing a channel, a UE may perform a contention-based channel access procedure to gain access to the unlicensed or shared radio frequency spectrum. For example, the UE may perform an LBT procedure (e.g., a clear channel assessment (CCA)) and determine whether signals from another device are detected on a channel or sub-channel. In the event that other signals associated with other devices are not detected, the UE may determine that the channel is available and transmit a reservation signal to indicate to other UEs that the channel is reserved for a channel occupancy time (COT).

In some cases, a UE may transmit one or more repetitions of a message in order to enhance the likelihood of successful reception of the message. In cases where an unlicensed or shared radio frequency spectrum is used by the UE, the availability of a channel for transmitting one or more repetitions of the message may be dependent upon a successfully completed contention-based channel access procedure (e.g., a LBT or CCA procedure). In some examples, resource reservation for one or more repetitions of a message may be identified relative to a channel occupancy time (COT) and determined based on a COT timing.

In some examples, sidelink transmissions are slot-based, such that a sidelink transmission starts on a slot boundary. However, some other communication protocols, such as WIFI, can transmit immediately upon clearing the LBT and may block the sidelink transmission. Therefore, some sidelink transmissions, such as sidelink transmissions in an unlicensed spectrum (e.g., SL-U), may face channel access starvation in the presence of other communication protocols, such as WIFI. Some communication systems, such as an NR-unlicensed spectrum (NR-U), have introduced mini-slot and slot search space switching. The mini-slot introduces a new transmission starting point, such that a transmitter may transmit within the mini-slot after clearing the LBT instead of waiting until a next slot boundary.

In some sidelink networks, two transmission starting positions may be implemented across a sidelink (SL) slot. As an example, one starting position may correspond to a half-slot, and another starting position may correspond to a full-slot. The half-slot may be an example of a mini-slot. In some examples, a half-slot structure with an automatic gain control (AGC) symbol and PSCCH/PSSCH symbols may be specified. The half-slot may be half of a full sidelink slot. In some such examples, the sidelink transmitter may be configured with a full-slot resource pool and a half-slot resource pool, which may overlap in time and frequency. The half-slot resource pool may be associated with one seven-symbol half-slot, which starts at symbol #7 and ends at symbol #13. The combination of the two types of resource pools provides the UE with an additional starting symbol. The transmitter may choose the resource pool with the earliest transmission starting point after clearing the LBT and, if the transmitter selects the half-slot resource pool, switch to the full-slot-based resource pool after an initial half-slot in the COT for better spectrum efficiency. From the receiver's point of view, because the AGC/PSCCH/PSSCH could start at either symbol #0 or symbol #7 based on the LBT outcomes, the receiver may be specified to monitor two PSSCH occasions in each (full) slot.

Various aspects of the present disclosure are directed to reducing transmitter and/or receiver complexity. In some examples, to reduce transmitter complexity, a same scrambling sequence may be used for the full-slot resource pool and the half-slot resource pool. In such examples, a sidelink UE may perform a listen-before-talk (LBT) for a channel occupancy time (COT) in a shared radio frequency band. A first or second starting symbol for an initial slot may be selected based on the timing associated with clearing the LBT. An initial seed for a first demodulation reference signal (DM-RS) allocated to a first symbol in the slot may be set to the same value as an initial seed for a second DM-RS allocated to a second symbol in the slot. During the COT, sidelink information is transmitted to a second sidelink UE via a sequence of slots that includes the initial slot.

In other examples, a DM-RS pattern rule may be specified for slots associated with multiple starting symbols. In such examples, a first or second starting symbol may be selected for an initial slot based on the timing associated with clearing the LBT. The initial slot may have a first total number of symbols in accordance with selecting the first starting symbol and a second total number of symbols in accordance with selecting the second starting symbol. Additionally, either a first or second DM-RS pattern may be selected from a group of DM-RS patterns based on the total number of symbols in the initial slot. Each DM-RS pattern in the group may be associated with a respective set of DM-RSs, where each DM-RS in the set is allocated to a respective symbol position within the initial slot. The symbol position associated with each DM-RS is relative to the first or second starting symbol.

Various aspects of the subject matter described may be implemented to realize one or more of the following potential advantages. The techniques employed by the base stations and UEs may provide benefits and enhancements to the operation of a wireless communications system. For example, operations performed by the UEs may reduce the complexity of a transmitter and/or a receiver. Reducing the complexity may decrease power use, thereby extending battery life.

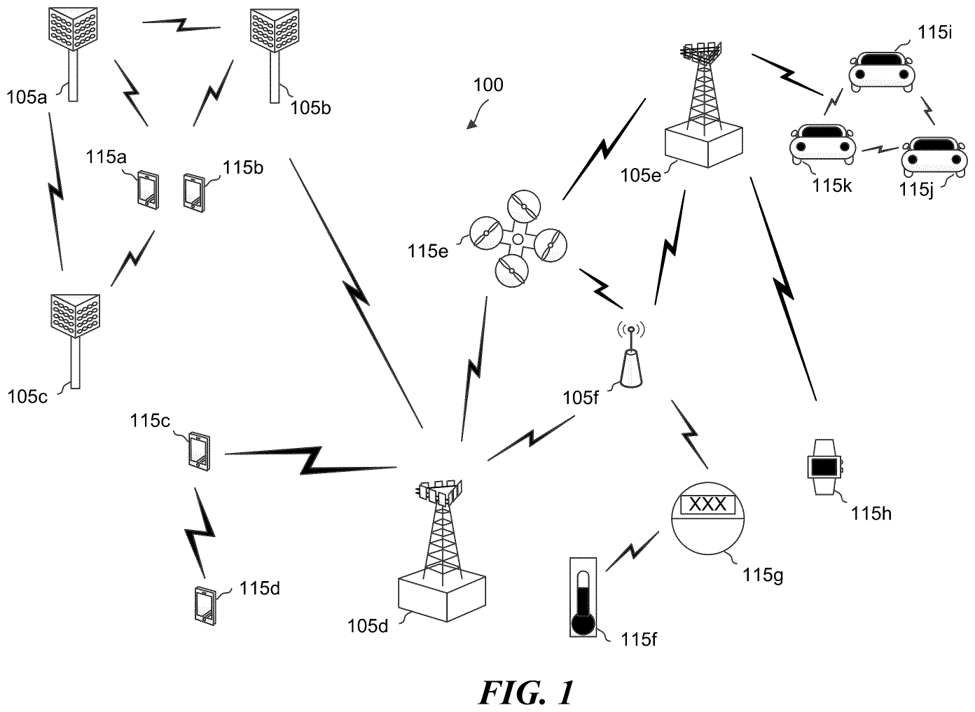

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS, which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless communication network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing wireless communication network 100. A UE 115 may also be a machine specifically configured for connected communication, including machine type communication (MTC), enhanced MTC (eMTC), narrowband IoT (NB-IoT), and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services, which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive an SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI, and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands or unlicensed frequency bands. For example, the network 100 may be an NR-unlicensed (NR-U) network operating over an unlicensed frequency band. In such an aspect, the BSs 105 and the UEs 115 may be operated by multiple network operating entities. To avoid collisions, the BSs 105 and the UEs 115 may employ an LBT procedure to monitor for transmission opportunities (TXOPs) in the shared channel. A wireless communication device may perform an LBT in the shared channel. LBT is a channel access scheme that may be used in the unlicensed spectrum. When the LBT results in an LBT pass (the wireless communication device wins contention for the wireless medium), the wireless communication device may access the shared medium to transmit and/or receive data. For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel. In an example, the LBT may be based on energy detection. For example, the LBT results in a pass when signal energy measured from the channel is below a threshold. Conversely, the LBT results in a failure when signal energy measured from the channel exceeds the threshold. In another example, the LBT may be based on signal detection. For example, the LBT results in a pass when a channel reservation signal (e.g., a predetermined preamble signal) is not detected in the channel. Conversely, the LBT results in a failure when a channel reservation signal is detected in the channel. A TXOP may also be referred to as channel occupancy time (COT).

Additionally, an LBT may be in a variety of modes. An LBT mode may be, for example, a category 4 (CAT4) LBT or a category 2 (CAT2) LBT. A CAT2 LBT refers to an LBT without a random backoff period. A CAT4 LBT refers to an LBT with a random backoff and a variable contention window (CW). A serving BS 105 may perform a CAT4 LBT to acquire a COT for communication with a UE. Additionally, the BS 105 may transmit a COT indication, for example, at the beginning of the COT, to indicate a duration of the COT and/or one or more subbands where the COT. The serving BS 105 may share the COT with a UE 115. To share the BS 105's COT, the UE may perform a CAT2 LBT within the BS 105's COT. Upon passing the CAT2 LBT, the UE may transmit a UL transmission within the BS 105's COT. A UE 115 may also acquire a COT outside of a COT of the serving BS 105 for UL transmission by performing a CAT4 LBT. In some instances, the UE 115 may also share the UE 115's COT with the BS 105. In some instances, the CAT4 LBT mode may be referred to as a type 1 LBT, and the CAT2 LBT mode may be referred to as a type 2 LBT.

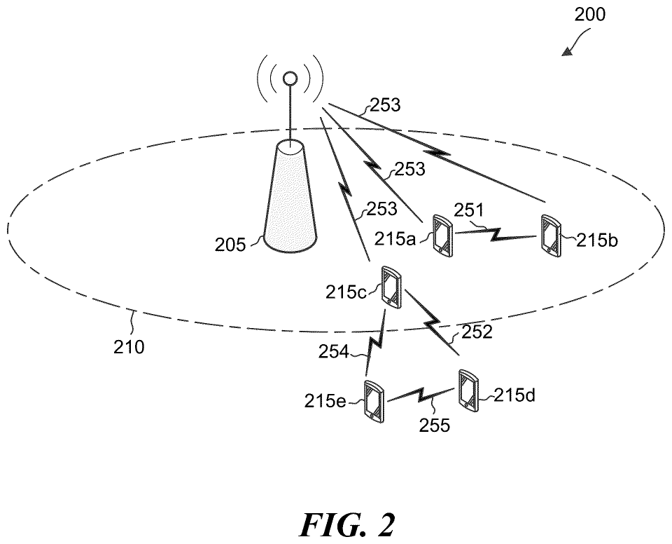

In some aspects, the network 100 may provision for sidelink communications to allow a UE 115 to communicate with another UE 115 without tunneling through a BS 105 and/or the core network as shown FIG. 2. As discussed above, sidelink communication can be communicated over a PSCCH and a PSSCH. For instance, the PSCCH may carry SCI and the PSSCH may carry SCI and/or sidelink data (e.g., user data). Each PSCCH is associated with a corresponding PSSCH, where SCI in a PSCCH may carry reservation and/or scheduling information for sidelink data transmission in the associated PSSCH. Sidelink communication can also be communicated over a physical sidelink feedback control channel (PSFCH), which indicates an acknowledgement (ACK)-negative acknowledgement (NACK) for a previously transmitted PSSCH.

FIG. 2 illustrates an example of a wireless communication network 200 that provisions for sidelink communications according to aspects of the present disclosure. The network 200 may correspond to a portion of the network 100. FIG. 2 illustrates one BS 205 and five UEs 215 (shown as 215a, 215v, 215c, 215d, and 215e) for purposes of simplicity of discussion, though it will be recognized that aspects of the present disclosure may scale to any suitable number of UEs 215 (e.g., the about 2, 3, 4, 5, 7 or more) and/or BSs 205 (e.g., the about 2, 3 or more). The BS 205 and the UEs 215 may be similar to the BSs 105 and the UEs 115, respectively. The BS 205 and the UEs 215 may share the same radio frequency band for communications. In some instances, the radio frequency band may be a licensed band. In some instances, the radio frequency band may be an unlicensed band (e.g., in a 5 GHz band). In some instances, the radio frequency band may be a frequency range 1 (FR1) band. In some instances, the radio frequency band may be a FR2 band. In general, the radio frequency band may be at any suitable frequency and may have any suitable bandwidth (e.g., about 5 MHz, about 10 MHz, about 20 MHz, about 80 MHz, about 100 MHz or more).

In the network 200, some of the UEs 215 may communicate with each other in peer-to-peer communications. For example, the UE 215a may communicate with the UE 215b over a sidelink 251, the UE 215c may communicate with the UE 215d over a sidelink 252 and/or with the UE 215e over a sidelink 254, and the UE 215d may communicate with the UE 215e over a sidelink 255. The sidelinks 251, 252, 254, and 255 are unicast bidirectional links. Some of the UEs 215 may also communicate with the BS 205 in a UL direction and/or a DL direction via communication links 253. For instance, the UE 215a, 215b, and 215c are within a coverage area 210 of the BS 205, and thus may be in communication with the BS 205. The UE 215d and UE 215e are outside the coverage area 210, and thus may not be in direct communication with the BS 205. In some instances, the UE 215c may operate as a relay for the UE 215d to reach the BS 205. In some aspects, some of the UEs 215 are associated with vehicles (e.g., similar to the UEs 115i-k) and the communications over the sidelinks 251 and/or 252 may be C-V2X communications. C-V2X communications may refer to communications between vehicles and any other wireless communication devices in a cellular network.

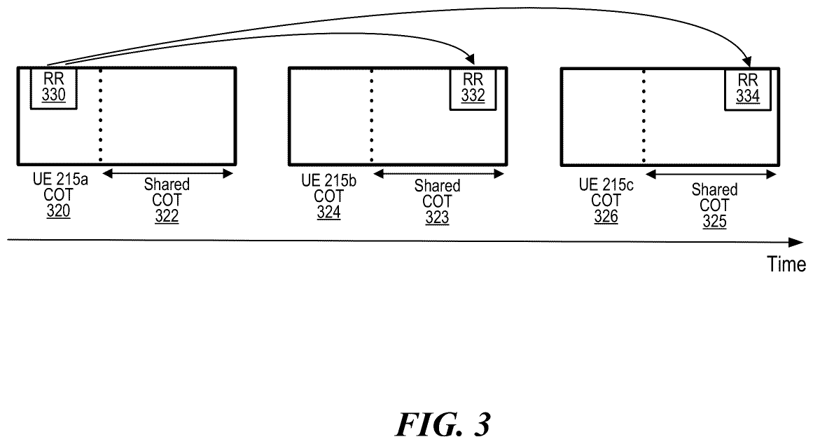

FIG. 3 illustrates reserved resources (e.g., time and frequency resources) for sidelink communications, according to some aspects of the present disclosure. In some instances, the methods of reserving resources in COTs may implement aspects of wireless communication network 100 or 200 as described above. In one example, a first UE may reserve resources in future COTs for sidelink communications with a peer UE.

For example, a first UE 215a (e.g., a UE 115 UE 215 of FIG. 1 or 2) may perform a LBT to obtain a UE COT 320 in a shared channel for communications, for example, with a peer sidelink UE. The LBT may be a CAT4 LBT. The LBT may be a pass indicating that the shared channel is clear for transmission. The first UE 215a may share a portion (shown as a first shared COT 322) with other UEs. That is, the first shared COT 322 may be used by other UEs for transmissions. Upon successfully obtaining first UE COT 320, the first UE 215a may provide a COT indication that identifies the first UE COT 320 and the first shared COT 322. The COT indication may include a start time, a duration, and/or an end time of the first UE COT 320, and/or a start time, a duration, and/or an end time of the first shared COT 322. Similarly, a second UE 215b may perform a LBT to obtain a second UE COT 324 in a shared channel for communications, for example, with a peer sidelink UE. The LBT may be a CAT4 LBT. The LBT may be a pass indicating that the shared channel is clear for transmission. The second UE 215b may share a portion (shown as a second shared COT 323) with other UEs. That is, the second shared COT 323 may be used by other UEs for transmissions. Upon successfully obtaining second UE COT 324, the second UE 215b may provide a COT indication that identifies the second UE COT 324 and the second shared COT 323. The COT indication may include a start time, a duration, and/or an end time of the second UE COT 324, and/or a start time, a duration, and/or an end time of the second shared COT 323. Similarly, a third UE 215c may perform a LBT to obtain a third UE COT 326 in a shared channel for communications, for example, with a peer sidelink UE. The LBT may be a CAT4 LBT. The LBT may be a pass indicating that the shared channel is clear for transmission. The third UE 215c may share a portion (shown as a third shared COT 325) with other UEs. That is, the third shared COT 325 may be used by other UEs for transmissions. Upon successfully obtaining the third UE COT 326, the third UE 215c may provide a COT indication that identifies the third UE COT 326 and the third shared COT 325. The COT indication may include a start time, a duration, and/or an end time of the third UE COT 326, and/or a start time, a duration, and/or an end time of the third shared COT 325.

In some instances, the first UE 215a may perform an LBT before the reserved resource 332 to obtain a COT so that the reserved resource 332 is within the first UE 215a's COT. Similarly, the first UE 215a may perform an LBT before the reserved resource 334 to obtain a COT so that the reserved resource 334 is within the first UE 215a's COT, and so on. Accordingly, the reserved resource 332 and the reserved resource 334 are within future COTs of the first UE 215a. In other instances, the reserved resources 332 and 334 can fall within another UE's COT. For instance, another UE 215b may perform an LBT to obtain the COT 324, and the reserved resource 332 can be within a shared portion (shown as 323 of the UE 215b's COT 324). For another example, another UE 215c may perform an LBT to obtain the COT 326, and the reserved resource 334 can be within a shared portion (shown as 325 of the UE 215c's COT 326).

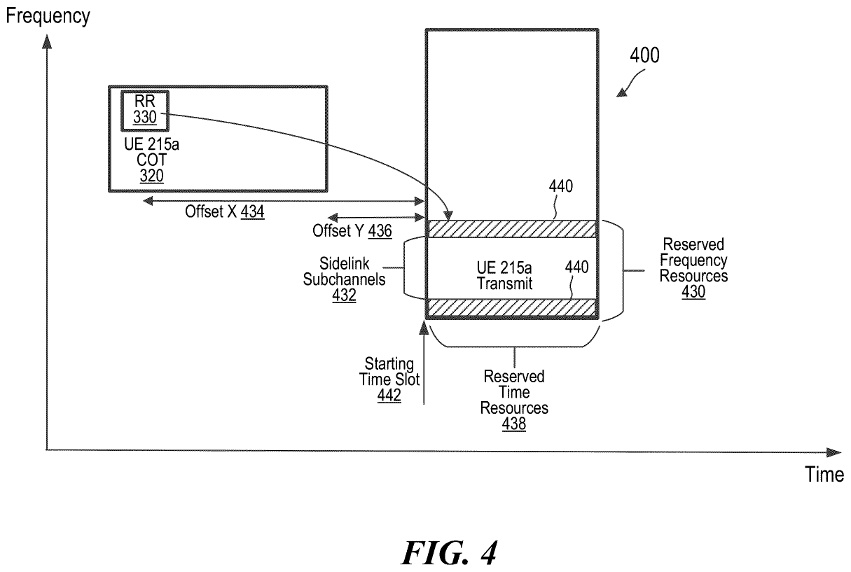

FIG. 4 illustrates reserved resources 400 for sidelink communications, according to some aspects of the present disclosure. In FIG. 4, the x-axis may represent time in some arbitrary units, and the y-axis may represent frequency in some arbitrary units. The reserved resources 400 may be reserved for a UE (e.g., UEs 115, UEs 215) performing sidelink communications in a wireless communications network (e.g., wireless communication network 100 or 200). For example, the resources 400 may be reserved for UE 215a retransmissions of a first transmission (e.g., retransmissions of a failed first transmission), for example, in a reserved resource (RR) 330. In some instances, UE 215a may transmit one or more transport blocks within COT 320. The UE 215a may also reserve future resources (e.g., one or more symbols or one or more time slots in time and one or more frequency subcarriers or one frequency subchannels in frequency) for retransmissions. In some instances, the UE 215a may reserve the future resources within the same COT 320 save overhead associated with the LBT. In other instances, the UE 215a may reserve the future resources in future COTs (after the COT 320). In the illustrated example of FIG. 4, the UE 215a reserves a future resource 400. The UE 215a may transmit, in the COT 320, an indication of a reservation for the future resources 400. Other UEs within communication range of the UE 215a may respect the resource reservation and refrain from contending for the reserved resources 400. Additionally, the other UEs may not transmit during a time period (e.g., about 1 symbol time) immediately before the reserved resources 400 so that the UE 215a may perform an LBT during that time period and gain access to the channel for transmission in the reserved resource 400. The time period to be used for LBT by the UE 215a may be referred to as a gap time period. The other UEs that receive the resource reservations may refrain from transmitting within the reserved resources and the gap time period. However, the other UEs may contend for resources outside of the reserved resources and the gap time period. In some instances, another UE may successfully obtain a COT before the gap time period, and may share a portion of the COT as discussed above with reference to FIG. 3. In some instances, the reserved resource 400 may be within the shared COT of the other's UE. In such instances, the UE 215a may perform a CAT2 LBT (instead of a CAT4 LBT) before transmitting in the reserved resources 400.

The UE 215a may reserve future reserved resources 400 by transmitting the resource reservation in a channel occupancy time system information (COT SI), for example, within SCI-1 and/or SCI-2. The COT SI may be transmitted within a COT that was obtained by performing an LBT (e.g., CAT4 LBT) to gain access to the COT 320. In some instances, the COT SI may be transmitted from a reserved resource 330. The resource reservation may include information related to the reserved resources 400. For example, the resource reservation may include information elements indicating the number of time slots (e.g., contiguous time slots) reserved within reserved time resources 438. The resource reservation may also include the number of frequency subchannels reserved in the reserved frequency resources 430. In some instances, the reserved frequency resources 430 may include sidelink subchannels 432 in which the UE 215a may transmit and frequency guard bands 440 on either side (e.g., an upper frequency edge and a lower frequency edge) of the sidelink subchannels in which the UE 215a may refrain from transmitting. For instance, in some aspects, a frequency band may be partitioned into multiple subchannels similar to the sidelink subchannels 432 with guard bands similar to the guard bands 440 between subchannels. The guard bands are inserted between subchannels to mitigate interference from neighboring subchannels. Thus, the guard bands are not to be used for transmissions, for example, when adjacent subchannels are used for transmission by different UEs.

In some instances, the resource reservation carried in the COT SI may include information related to the starting time slot 442 of the reserved resources 400. For example, the resource reservation in the COT SI may indicate a timing offset Y 436 that indicates the timing of the starting time slot 442 based on an amount of time from the end of the COT 320 in which the resource reservation carried in the COT SI was transmitted. Stated differently, the COT SI may indicate a starting time of the resource 400 with respect to the end of the COT 320 in which the resource reservation carried in the COT SI was transmitted. In some instances, the UE 215a may transmit multiple COT SIs within the current COT 320, for example, to indicate the end of the current COT 320.

As another example, the resource reservation in the COT SI may indicate a timing offset X 434 that indicates the timing of the starting time slot 442 based on an amount of time from the transmission of the COT SI. Stated differently, the COT SI may indicate a starting time of the resource 400 with respect to a transmission time of the COT SI that reserves the resource 400. For example, offset X 434 may be the amount of time from the beginning of the time slot in which the COT SI was transmitted. As another example, offset X 434 may be the amount of time from the end of the time slot in which the COT SI was transmitted.

As discussed, in some cases, prior to accessing a channel, a UE may perform a contention-based channel access procedure to gain access to the unlicensed or shared radio frequency spectrum. For example, the UE may perform a listen-before-talk (LBT) procedure (e.g., a clear channel assessment (CCA)) and determine whether signals from another device are detected on a channel or sub-channel. In the event that other signals associated with other devices are not detected, the UE may determine that the channel is available and transmit a reservation signal to indicate to other UEs that the channel is reserved for a channel occupancy time (COT).

In some cases, a UE may transmit one or more repetitions of a message in order to increase a likelihood of a successful message reception. In cases where an unlicensed or shared radio frequency spectrum is used by the UE, an availability of a channel for transmitting one or more repetitions of the message may depend on successfully completing a contention-based channel access procedure (e.g., a LBT or CCA procedure).

In some examples, resource reservation for one or more repetitions of a message may be identified relative to a channel occupancy time (COT) and determined based on a COT timing. In some cases, a first UE may transmit a first message to a second UE during a first COT and may reserve resources of one or more subsequent COTs for one or more repetitions of the first message. The first UE may transmit an indication of a reservation for reserved resources. In some cases, the reserved resources may be identified based, at least in part, on a two stage resource reservation, in which reserved resources are identified relative to a timing of a reservation indication transmission or an end of the first COT. In such cases, the first UE may first determine a timing of a second COT and then determine a timing of the reserved resources based on the timing of the second COT. In some cases, the reserved resources may be identified based on one or more offsets from a starting time of the second COT. The first UE may transmit one or more additional instances of the first message using the reserved resources.

In some examples, the reserved resources may be indicated via sidelink control information (SCI) transmitted from the first UE. In some cases, one or more of the reserved resources may be within shared COTs that are obtained (contended and won) by a UE that is different than the first UE. The UEs receiving the SCI indicating the reserved resources may respect the reservations by refraining from transmitting during a period (e.g., 0.5 ms to 2 ms, 1 symbol, or 2 symbols) immediately before each reserved resource and during each reserved resource within the one or more subsequent COTs. However, if the reserved resources are unused by the reserving UE, the other UEs may contend for the reserved resources.

In some examples, sidelink transmissions are slot-based, such that a sidelink transmission starts on a slot boundary. However, some other communication protocols, such as WIFI, can transmit immediately upon clearing the LBT and may block the sidelink transmission. Therefore, some sidelink transmissions, such as sidelink transmissions in an unlicensed spectrum (e.g., SL-U), may face channel access starvation in the presence of other communication protocols, such as WIFI. Some communication systems, such as NR-U, have introduced mini-slot and slot search space switching, which allows a transmitter to transmit within a mini-slot after clearing the LBT instead of waiting until a next slot boundary.

In some sidelink networks, two transmission starting positions may be implemented across a sidelink (SL) slot. As an example, one starting position may correspond to a half-slot, and another starting position may correspond to a full-slot. In some examples, a half-slot structure with an automatic gain control (AGC) symbol and PSCCH/PSSCH symbols may be specified. The half-slot may be half of a full sidelink slot. For example, the sidelink transmitter may be configured with a full-slot resource pool and a half-slot resource pool, which may overlap in time and frequency. The half-slot resource pool may be associated with one seven-symbol half-slot, which starts at symbol #7 and ends at symbol #13. The combination of the two types of resource pools provides the UE with an additional starting symbol. The transmitter may choose the resource pool with the earliest transmission starting point after clearing the LBT and, if the transmitter selects the half-slot resource pool, switch to the full-slot-based resource pool after an initial half-slot in the COT for better spectrum efficiency. From the receiver's point of view, because the AGC/PSCCH/PSSCH could start at either symbol #0 or symbol #7 based on the LBT outcomes, the receiver may be specified to monitor two PSSCH occasions in each (full) slot.

For slots with two candidate stating symbols for a sidelink transmission, such as a PSCCH or PSSCH transmission, a location of a first and second starting symbol may be pre-configured per bandwidth part (BWP). For example, the location of the first starting symbol may be any one of symbols #0 to #6. If the first starting symbol is not pre-configured, the first starting symbol is symbol #0. Additionally, the location of the second starting symbol may be any one of symbols #3 to #7. A number of symbols from the second starting symbols is greater than or equal to six. Furthermore, within a slot the second starting symbol is after the first starting symbol. A sidelink transmission starting from the first or second starting symbol has the same ending symbol within the slot.

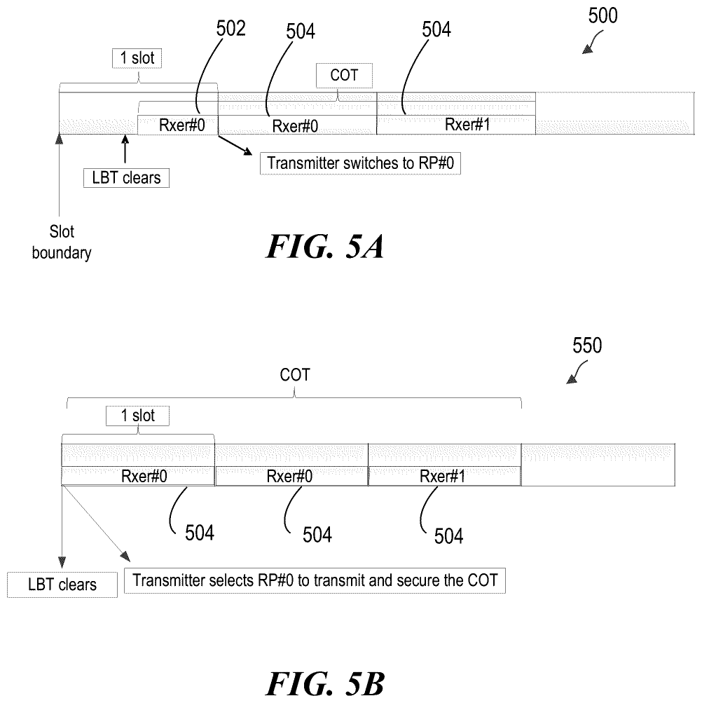

FIG. 5A is a block diagram illustrating an example 500 of a transmitter selecting a half-slot resource pool 502 in accordance with an LBT clearing after a slot boundary, in accordance with various aspects of the present disclosure. As shown in the example 500, the LBT clears after the slot boundary and before a starting point of a half-slot resource pool (RP) 502 (RP #1) within a slot. Therefore, to secure the COT, the transmitter may use the half-slot RP 502 in a first slot and use full-slot RPs 504 (RP #0) in subsequent slots. In some examples, the RPs 502 and 504 may be designated for transmissions to different receivers (shown as Rxer #0 and Rxer #1). In some such examples, a first receiver (Rxer #0) may be a high capability receiver and a second receiver (Rxer #1) may be a low capability receiver.

FIG. 5B is a block diagram illustrating an example 550 of a transmitter selecting a full-slot resource pool 504 in accordance with an LBT clearing after a slot boundary, in accordance with various aspects of the present disclosure. As shown in the example 550, the LBT clears at the slot boundary. Therefore, to secure the COT, the transmitter may use the full-slot RP 504 (RP #0) for all slots associated with the COT. In some examples, the RPs 502 and 504 may be designated for transmissions to different receivers (shown as Rxer #0 and Rxer #1).

In some examples, a capability of a UE and a type of cast (e.g., broadcast, groupcast, multicast) may determine whether the UE (e.g., receiver) monitors both the half-slot RP (e.g., mini-slot) and the full-slot RP, or only the full-slot RP. For example, groupcast or broadcast transmissions may be limited to the full-slot RP. In some examples, the transmitter may schedule transmissions to high capability UEs through the mini-slot RP or a combination of a half-slot RP and a full-slot RP at the start of the data burst. In some examples, a conventional hybrid automatic repeat request (HARQ) timeline and the physical sidelink feedback channel (PSFCH) mapping rule may be used for the half-slot RP and full-slot RP. In situations where the PSFCH instance aligns with the current slot, the transmitter designates the last two symbols of the half-slot to the PSFCH.

As discussed, half-slot channel access (e.g., mini-slot channel access) may improve the reliability of transmissions on sidelink unlicensed bands (SL-U) when WIFI or other radio access technologies (RATs) are present. For example, if a link is configured to support half-slot channel access, the receiver may monitor sidelink control information (SCI) at multiple starting symbols within a slot. The UE implementation may be feasible if the number of PSCCH candidates per slot is less than or equal to 44 because the UE could support up to 44 blind PDCCH hypotheses in a cellular link (e.g., Uu link). The number of PSCCH candidates per (full) slot, when half-slots are supported, equals the number of subchannels×2. For example, for SCS 30 KHz, the receiver could support up to 80 MHz if five subchannels are included per 20 MHz, while for SCS 15 KHz, up to 40 MHz can be supported with ten subchannels per 20 MHz.

For an initial slot of a COT, a transport block size (TBS) may be based on a predetermined number of resources. In some examples, these resources are half-slot resources. In such examples, a full-slot PSSCH may be rate-matched to align with full-slot resources. In some other examples, the resources are full-slot resources. In such examples, the transmitter may puncture the half-slot PSSCH resource elements (REs). That is, the transmitter may omit certain REs from the half-slot PSSCH.

In some examples, a UE timeline may not accommodate re-encoding the PSSCH following the results of the LBT. In some such examples, if the transmitter configures a transport block (TB) anticipating a full-slot allocation and the LBT fails, the transmitter may re-encode the data to accommodate a half-slot allocation. Therefore, the transmitter complexity may increase by encoding multiple hypotheses with different TB sizes. In some examples, transmitter complexity may be reduced by avoiding multiple encoding hypotheses with different TB sizes (TBSs) based on the first slot of the COT being a full-slot or half-slot transmission. In some such examples, the transmitter can determine the TBS for the first (full or half) slot of the COT transmission based on the half-slot worth of resources. In some implementations, if half-slot channel access is enabled, the TBS for the first slot (full-slot or half-slot depending on LBT outcome) of the COT transmission may be selected based only on half-slot resources or full-slot resources. In such examples, transmitter complexity may be reduced by avoiding multiple encoding hypotheses with different transport block (TB) sizes.

In some examples, to avoid re-encoding hypotheses for the PSCCH and/or the PSSCH, the transmitter may configure two separate waveform hypotheses for the PSCCH and PSSCH. Such waveforms may be stored within a designated buffer. In such examples, the transmitter may store both full-slot and half-slot waveform hypotheses. The transmitter may select one of these waveforms in accordance with an outcome of the LBT. Specifically, the transmitter may select one of these waveforms in accordance with a timing of the LBT clearance within a given slot. Depending on the timing of the LBT clearance, the transmitter may map and rate-match the PSCCH and PSSCH to either a half-slot or a full-slot. This mapping produces an inverse fast Fourier transform (IFFT) waveform.

For an initial slot of a COT, a TBS may be based on a predetermined number of resources (e.g., a reference number of symbols). In some examples, these resources are half-slot resource. In such examples, a full-slot PSSCH may be rate-matched to align with full-slot resources. In some other examples, the resources are full-slot resources. In such examples, the transmitter may puncture the half-slot PSSCH resource elements (REs). That is, the transmitter may omit certain REs from the half-slot PSSCH.

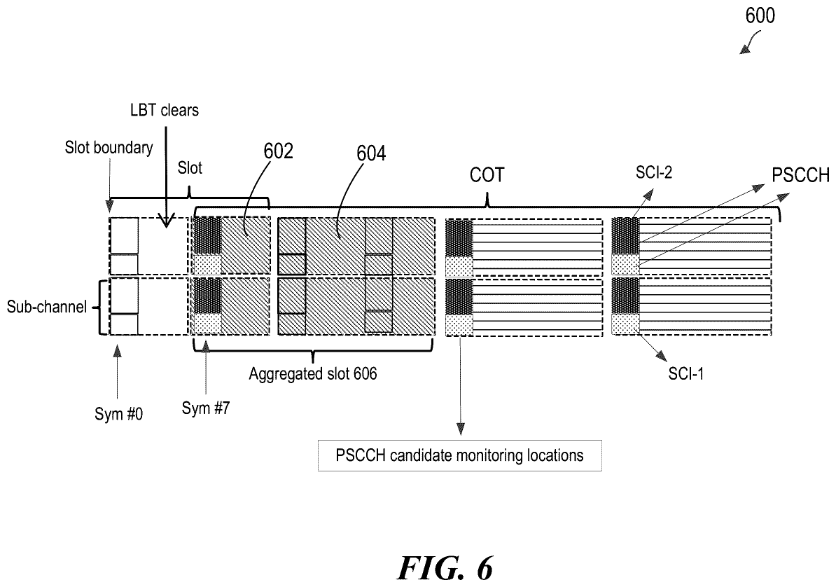

FIG. 6 is a block diagram illustrating another example 600 of an aggregated half-slot 602 and full-slot 604, in accordance with various aspects of the present disclosure. As shown in the example of FIG. 6, the transmitter may aggregate a half-slot 602 and a full-slot 604 to generate an aggregated slot 606 based on the LBT clearance occurring after a slot boundary and before a starting symbol (symbol #7) associated with the half-slot. The example of FIG. 6 shows slots for multiple sub-channels. Aspects of the present disclosure are contemplated for one or more sub-channels.

As shown in the example of FIG. 6, a PSCCH may be allocated to a second starting symbol (Sym #7) of the half-slot 602 and a first starting symbol (e.g., Sym #0) of the full-slot 604. For case of explanation, only one PSCCH is labeled in FIG. 6. Each PSCCH may include first sidelink control information (SCI-1) and second sidelink control information (SCI-2). The SCI-1 may indicate the combination of the half-slot 602 and the full-slot 604 (e.g., the aggregated slot 606). In some examples, a common demodulation reference signal (DM-RS) pattern may be specified, regardless of whether the PSCCH starts in the half-slot 602 or the full-slot 604. The SCI-1 may signal the combination of the half and full-slot. In the example of FIG. 6, the transport block size (TBS) is based on resources from one slot. Depending on a timing of the LBT clearance, rate-matching and IFFT waveform generation begins either from a first starting symbol (e.g., symbol #0) or a second starting symbol (e.g., symbol #7).

In some cases, a set of DM-RSs may be transmitted via a sidelink channel, such as the PSSCH. A demodulation reference signal (DM-RS) scrambling sequence for the sidelink channel may depend on a symbol index n_{s,f}^{μ}. An initial seed for a scrambling sequence may be generated as follows: cᵢₙᵢₜ=(2¹⁷(N_{symb}^{slot}n_{s,f}^{μ}+l+1)(2N_{ID}+1)+2N_{ID}) mod 2³¹, where l is a symbol in a slot associated with a position of the DM-RS, N_{symb}^{slot} is a number of symbols per slot, and N_{ID} is a cell ID. The initial seed for the scrambling sequence scrambles the data (e.g., control information) on the sidelink channel. The scrambling ensures the signal can be distinguished from other signals and noise in the wireless environment. The scrambling sequence itself is defined to be symbol-independent for sidelink information symbols (e.g., PSCCH and PSSCH information symbols), such that the scrambling sequence does not change with each symbol. However, the DM-RS pattern may vary depending on the number of PSSCH symbols, and the relative DM-RS symbol location may differ in accordance with the first or second starting symbols.

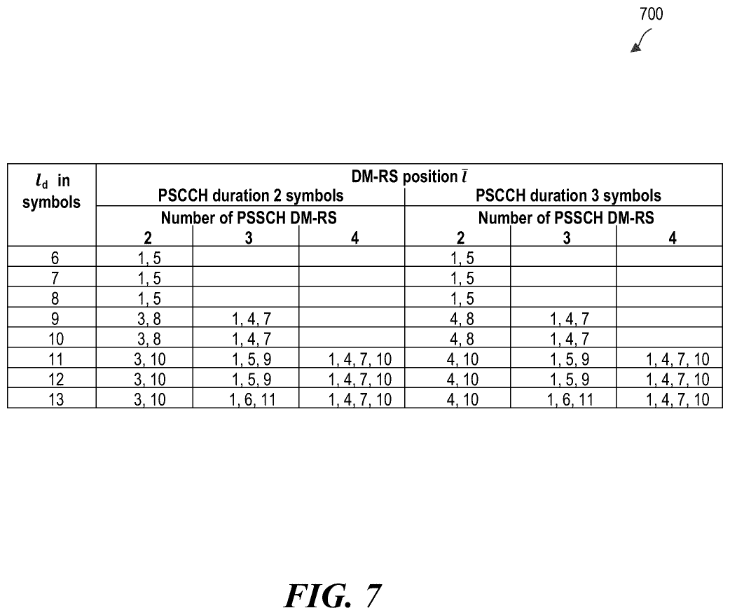

Allocating DM-RSs in a PSSCH in accordance with a number of symbols. As shown in FIG. 7, a position of the DM-RS l̅ may be based on a total number of symbols l_{d} allocated to a particular PSCCH or PSSCH. The table also differentiates between a number of DM-RS allocated to the respective channel. In the example of FIG. 7, the configuration accounts for two, three, or four DM-RSs. A symbol position for the DM-RSs l̅ is based on the number of DM-RSs. For example, if the total number of symbols l_{d} is six, and there are two PSSCH DM-RSs, the DM-RSs may be placed at symbol #1 and symbols #5 for both a two symbol PSCCH and a three symbol PSCCH. In some cases, the half-slot channel access may increase receiver and/or transmitter complexity, which may decrease bandwidth. For example, as discussed, a transmitter may use a full-slot RP or a half-slot RP for a PSSCH based on when an LBT clears—either at the start or mid-way through the slot. Various aspects of the present disclosure are directed to reducing transmitter and/or receiver complexity.

In some examples, to reduce transmitter complexity, multiple hypotheses for initial symbols (e.g., starting symbols) may share both the same coded bits and the same modulation symbols prior to the inverse fast Fourier transformation (IFFT). In such examples, frequency domain (FD) in-phase and quadrature (IQ) samples are not regenerated. Rather, the transmitter (e.g., transmitter UE) may retrieve the pre-calculated FDIQ samples from a buffer and perform the IFFT. Additionally, or alternatively, in some examples, a same scrambling sequence may be used for the full-slot resource pool and the half-slot resource pool. In such examples, a sidelink UE may perform a listen-before-talk (LBT) for a channel occupancy time (COT) in a shared radio frequency band. A first or second starting symbol for an initial slot may be selected based on the timing associated with clearing the LBT. An initial seed for a first demodulation reference signal (DM-RS) allocated to an i^{th} symbol after the first starting symbol in the slot may be set to a same value as an initial seed for a second DM-RS allocated to an i^{th} symbol after a second starting symbol in the slot. During the COT, sidelink information is transmitted to a second sidelink UE via a sequence of slots that includes an initial slot.

In such examples, an initial seed for the first scrambling sequence is based on an offset between a symbol number of the first starting symbol and a symbol number of a symbol used for the first DM-RS. Additionally, an initial seed for the second scrambling sequence may be based on an offset between a symbol number of the second starting symbol and a symbol number of a symbol used for the second DM-RS.

For example, the first starting symbol may be symbol #m. In this example, the initial seed for the scrambling sequence for the DM-RS on the i^{th} symbol after the first starting symbol is cᵢₙᵢₜ=(2¹⁷(N_{symb}^{slot}n_{s,f}^{μ}+m+i+1)(2N_{ID}+1)+2N_{ID})mod 2³¹. For the i^{th} symbol of the sidelink transmission starting at, or after, the second starting symbol, the same initial seed is reused cᵢₙᵢₜ=(2¹⁷(N_{symb}^{slot}n_{s,f}^{μ}+m+i+1)(2N_{ID}+1)+2N_{ID})mod 2³¹. In this example, the scrambling sequence for DM-RS is based on a relative offset with respect to symbol #m of the first starting symbol. That is, in this example, m represents the symbol number for the first starting symbol, and i represents the symbol number for the i^{th} symbol allocated for DM-RS after the second starting symbol.

The initial slot may include an automatic gain control (AGC) symbol followed by physical sidelink control channel (PSCCH) symbols and/or physical sidelink shared channel (PSSCH) symbols. The first starting symbol is preconfigured as any one of symbols #0 to #6 in the initial slot, or set to symbol #0 as default. The second starting symbol may be preconfigured as any one of symbols #3 to #7 in the initial slot, with the second starting symbol being after the first starting symbol. The total number of symbols allocated for sidelink information in the initial slot from the second starting symbol to the final symbol is greater than or equal to six, inclusive of both the second starting symbol and the final symbol. The DM-RS may be a PSCCH DM-RS or a PSSCH DM-RS. In addition, the same final symbol is used for the initial slot, regardless of selecting the first starting symbol or the second starting symbol.

In some other examples, a DM-RS pattern rule may be specified for slots associated with multiple starting symbols. In such examples, a first or second starting symbol may be selected for an initial slot based on the timing associated with clearing the LBT. A total number of symbols allocated to an initial slot may be based on selecting the first starting symbol or the second starting symbol. Additionally, a DM-RS pattern may be selected from a group of DM-RS patterns based on the total number of symbols in the initial slot. Each DM-RS pattern in the group may be associated with a set of DM-RSs, where each DM-RS in the set is allocated to a symbol position within the initial slot. The symbol position may correspond to the symbol position shown in the table 700 described with reference to FIG. 7. Additionally, the symbol position may be relative to the first or second starting symbol.

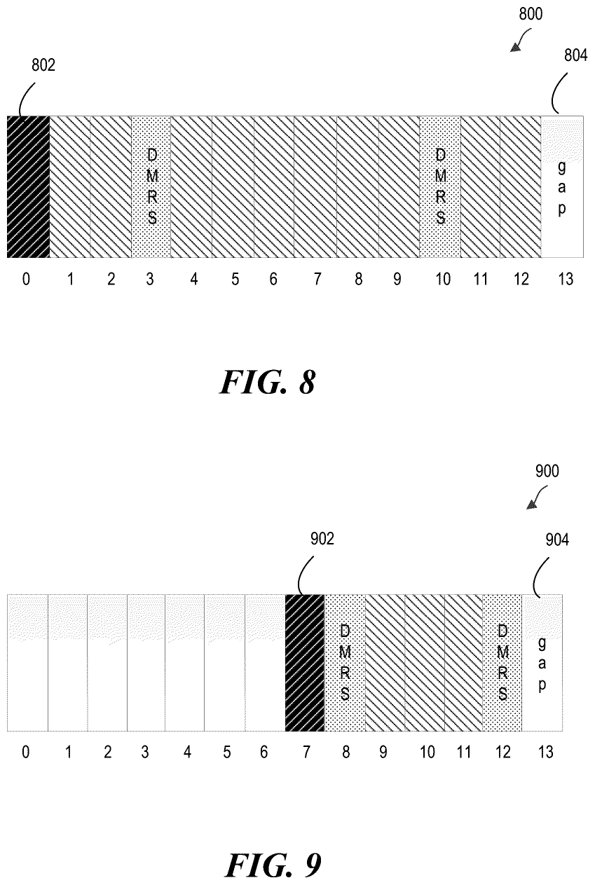

FIG. 8 is a diagram illustrating an example of an initial slot 800, in accordance with various aspects of the present disclosure. In the example of FIG. 8, the initial slot 800 is a full-slot that includes fourteen symbols, numbered #0 to #13. However, for the purposes of allocating DM-RSs based on an allocation table, such as the table 700 described with reference to FIG. 7, the initial slot includes thirteen symbols because a final symbol 804 is a gap symbol. A first symbol 802 (e.g., starting symbol) of the initial slot 800 is an automatic gain control (AGC) symbol. In the example of FIG. 8, a PSSCH duration is two symbols and a number of PSSCH DM-RSs is two. Therefore, in accordance with the table 700 described with reference to FIG. 7, the DM-RSs are allocated to a third symbol relative to the starting symbol (e.g., symbol #3 in the initial slot 800) and a tenth symbol relative to the starting symbol (e.g., symbol #10 in the first initial slot 800).

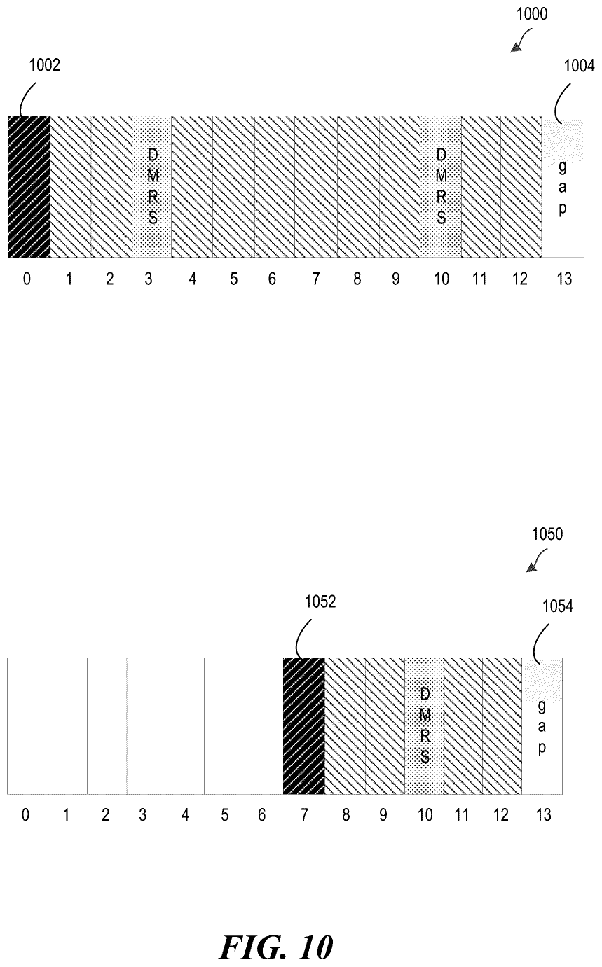

FIG. 9 is a diagram illustrating an example of an initial slot 900, in accordance with various aspects of the present disclosure. In the example of FIG. 9, the initial slot 900 is a half-slot that includes seven symbols, numbered #7 to #13. However, for the purposes of allocating DM-RSs based on an allocation table, such as the table 700 described with reference to FIG. 7, the initial slot includes six symbols because a final symbol 904 is a gap symbol. A first symbol 902 (e.g., starting symbol) of the initial slot 900 is an AGC symbol. In the example of FIG. 9, a PSSCH duration is two symbols and a number of PSSCH DM-RSs is two. Therefore, in accordance with the table 700 described with reference to FIG. 7, the DM-RSs are allocated to symbol #8 (e.g., a first symbol relative to the starting symbol) and symbol #12 (e.g., a fifth symbol relative to the starting symbol).

In some examples, the second DM-RS pattern associated with a second starting symbol may be the same as the first DM-RS pattern associated with a first starting symbol. In such examples, the symbol position associated with each DM-RS of the respective DM-RS patterns is relative to the first or second starting symbol. In some such examples, one or more DM-RS associated with the second DM-RS pattern may be punctured based on their respective symbol position being outside the range of symbol positions associated with the initial slot. That is, if one or more DM-RSs included in a DM-RS pattern assigned to a starting symbol extends beyond a range of symbols in an initial slot, the one or more DM-RSs may be omitted.

FIG. 10 is a diagram illustrating an example of dropped out-of-bounds DM-RSs, in accordance with various aspects of the present disclosure. In the example of FIG. 10, a first initial slot 1000 is a full-slot that includes fourteen symbols, numbered #0 to #13. However, for the purposes of allocating DM-RSs based on an allocation table, such as the table 700 described with reference to FIG. 7, the first initial slot includes thirteen symbols because a final symbol 1004 is a gap symbol. A first symbol 1002 (e.g., starting symbol) of the initial slot 1000 is an automatic gain control (AGC) symbol. In the example of FIG. 10, a PSSCH duration is two symbols and a number of PSSCH DM-RSs is two. Therefore, in accordance with the table 700 described with reference to FIG. 7, the DM-RSs are allocated to a third symbol relative to the starting symbol (e.g., symbol #3 in the first initial slot 1000) and a tenth symbol relative to the starting symbol (e.g., symbol #10 in the first initial slot 1000).

Additionally, in the example of FIG. 10, a second initial slot 1050 is a half-slot that includes seven symbols, numbered #7 to #13. However, for the purposes of allocating DM-RSs based on an allocation table, such as the table 700 described with reference to FIG. 7, the initial slot includes six symbols because a final symbol 1054 is a gap symbol. A first symbol 1052 (e.g., second starting symbol) of the initial slot 1050 is an AGC symbol. In the example of FIG. 10, a second DM-RS pattern of the second initial slot 1050 is specified to match a first DM-RS pattern of the first initial slot 1000. Therefore, the DM-RSs for the second initial slot 1050 should be assigned to the third symbol (e.g., symbol #10 in the second initial slot 1050) that is relative to the second starting symbol 1052 and a tenth symbol that is relative to the second starting symbol 1052. In this example, the tenth symbol that is relative to the second starting symbol 1052 is out of range of the symbols allocated to the second initial slot 1050. Therefore, a transmitted (e.g., UE) punctures (e.g., drops) a DM-RS associated with the tenth symbol that is relative to the second starting symbol.

In some examples, it may be desirable for each slot to include two or more DM-RSs. For example, in vehicle-to-vehicle communication, two or more DM-RSs may improve an accuracy of Doppler shift estimations. In such examples, the first DM-RS pattern may include three or more DM-RSs such that the half-slot may include at least two DM-RSs. For example, if a thirteen symbol configuration is linked to the first starting symbol, the DM-RS may be assigned to a first, fourth, seventh, and tenth symbol relative to the first starting symbol, in accordance with the table 700 described with reference to FIG. 7. In this example, if the half-slot includes six symbols, the DM-RS pattern associated with the second starting symbol may discard the DM-RS at the seventh and tenth symbols relative to the second starting symbol. Consequently, the DM-RS would be assigned the first and fourth symbols relative to the starting symbol. In this example, the {1, 4} is similar to the {1, 5} configuration of the table 700 described with reference to FIG. 7. As shown in the table 700 the {1, 5} configuration is specified for a six symbol sequence.

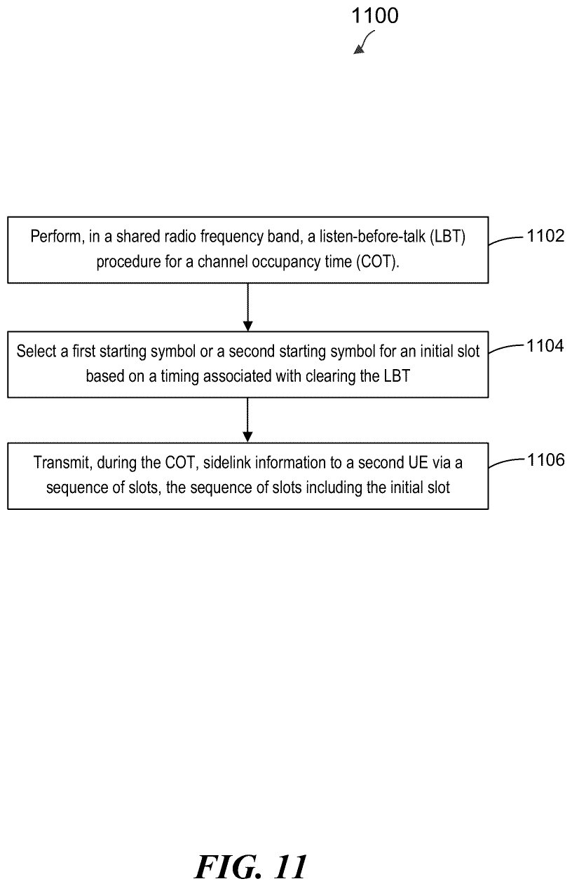

FIG. 11 is a flow diagram illustrating an example process 1100 performed by a UE 215, in accordance with some aspects of the present disclosure. The example process 1100 is an example of selecting a scrambling sequence for one or more DM-RSs transmitted in a slot associated with a group of candidate starting symbols. As shown in the example of FIG. 11, the process 1100 begins at block 1102 by performing, in a shared radio frequency band, a listen-before-talk (LBT) procedure for a channel occupancy time (COT). The LBT procedure determines whether signals from another device are detected on a channel or sub-channel. In the event that other signals associated with other devices are not detected, the UE may determine that the channel is available and transmit a reservation signal to indicate to other UEs that the channel is reserved for the COT.

At block 1104, the process selects a first starting symbol or a second starting symbol for an initial slot based on a timing associated with clearing the LBT. The first starting symbol may be associated with a full-slot and the second starting symbol may be associated with a half-slot. The initial seed for a first scrambling sequence for a first demodulation reference signal (DM-RS) allocated to a first symbol, in the initial slot, after the first starting symbol may be the same as an initial seed for a second scrambling sequence for a second DM-RS allocated to a second symbol, in the initial slot, after the second starting symbol. At block 1106, the process 1100 transmits, during the COT, sidelink information to a second UE via a sequence of slots, the sequence of slots including the initial slot.

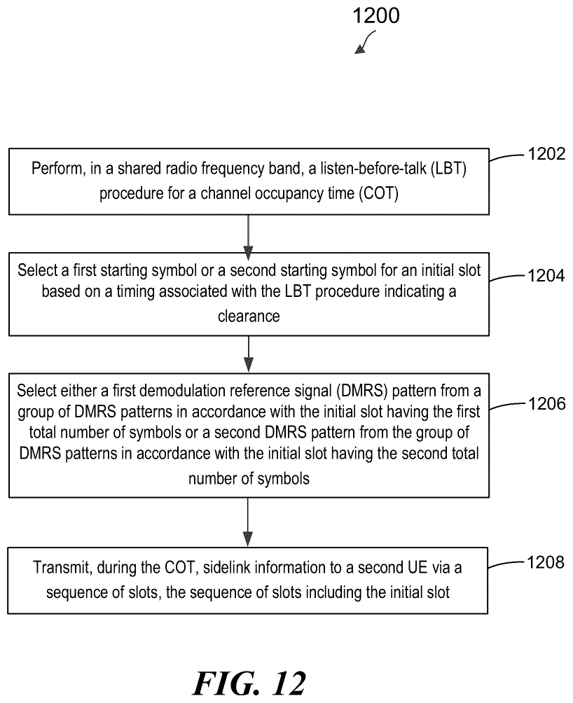

FIG. 12 is a flow diagram illustrating an example process 1200 performed by a UE 215, in accordance with some aspects of the present disclosure. The example process 1200 is an example of selecting a DM-RS pattern for one or more DM-RSs transmitted in a slot associated with a group of candidate starting symbols. As shown in FIG. 12, the process 1200 begins at block 1202 by performing, in a shared radio frequency band, a listen-before-talk (LBT) procedure for a channel occupancy time (COT). The LBT procedure determines whether signals from another device are detected on a channel or sub-channel. In the event that other signals associated with other devices are not detected, the UE may determine that the channel is available and transmit a reservation signal to indicate to other UEs that the channel is reserved for the COT.

At block 1204, the process 1200 selects a first starting symbol or a second starting symbol for an initial slot based on a timing associated with the LBT procedure indicating a clearance. The initial slot may have a first total number of symbols in accordance with selecting the first starting symbol and a second total number of symbols in accordance with selecting the second starting symbol. The first starting symbol may be associated with a full-slot and the second starting symbol may be associated with a half-slot.

At block 1206, the process 1200 selects either a first demodulation reference signal (DM-RS) pattern from a group of DM-RS patterns in accordance with the initial slot having the first total number of symbols or a second DM-RS pattern from the group of DM-RS patterns in accordance with the initial slot having the second total number of symbols. Each of the group of DM-RS patterns is associated with a respective set of DM-RSs. Additionally, each DM-RS of the respective set of DM-RSs is allocated to a respective symbol position of a group symbols positions within the initial slot. Furthermore, the respective symbol position associated with each DM-RS of the set of DM-RSs is relative to the first starting symbol or the second starting symbol in accordance with selecting the first starting symbol or the second starting symbol.

At block 1208, the process 1200 transmits, during the COT, sidelink information to a second UE via a sequence of slots, the sequence of slots including the initial slot. An initial symbol of the initial slot is an automatic gain control (AGC) symbol, such as an AGC symbol 1002 or 1052 described with respect to FIG. 10. Each remaining symbol of the initial slot is one of a physical sidelink control channel (PSCCH) symbol or a physical sidelink shared channel (PSSCH) symbol.

### Example Aspects

Implementation examples are described in the following numbered clauses:

Clause 1. A method for wireless communication at a first user equipment (UE), comprising: performing, in a shared radio frequency band, a listen-before-talk (LBT) for a channel occupancy time (COT); selecting a first starting symbol or a second starting symbol for an initial slot based on a timing associated with clearing the LBT, an initial seed for a first scrambling sequence for a first demodulation reference signal (DM-RS) allocated to a first symbol, in the initial slot, after the first starting symbol being the same as an initial seed for a second scrambling sequence for a second DM-RS allocated to a second symbol, in the initial slot, after the second starting symbol; and transmitting, during the COT, sidelink information to a second UE via a sequence of slots, the sequence of slots including the initial slot.

Clause 2. The method of Clause 1, in which: the initial seed for the first scrambling sequence is based on an offset between a symbol number of the first starting symbol and a symbol number of the first symbol used for the first DM-RS; and the initial seed for the second scrambling sequence is based on an offset between a symbol number of the first starting symbol and a symbol number of the second symbol used for the second DM-RS.

Clause 3. The method of any one of Clauses 1-2, in which: an initial symbol of the initial slot is an automatic gain control (AGC) symbol; and each remaining symbol of the initial slot is one of a physical sidelink control channel (PSCCH) symbol or a physical sidelink shared channel (PSSCH) symbol.

Clause 4. The method of any one of Clauses 1-3, in which: the first starting symbol is preconfigured as any one of symbols zero to six in the initial slot or set to symbol zero as default; and the second starting symbol is preconfigured as any one of symbols three to seven in the initial slot.

Clause 5. The method of any one of Clauses 1-4, in which the second starting symbol is after the first starting symbol.

Clause 6. The method of any one of Clauses 1-5, in which a total number of symbols allocated for the sidelink information, in the initial slot, from the second starting symbol to a final symbol is greater than or equal to six, inclusive of both the second starting symbol and the final symbol.

Clause 7. The method of any one of Clauses 1-6, in which the initial slot uses a same final symbol regardless of selecting the first starting symbol or the second starting symbol.

Clause 8. The method of any one of Clauses 1-7, in which each of the first DM-RS and the second DM-RS is a physical sidelink control channel (PSCCH) DM-RS or a physical sidelink shared channel (PSSCH) DM-RS.

Clause 9. A method for wireless communication at a first user equipment (UE), comprising: performing, in a shared radio frequency band, a listen-before-talk (LBT) procedure for a channel occupancy time (COT); selecting a first starting symbol or a second starting symbol for an initial slot based on a timing associated with the LBT procedure indicating a clearance, the initial slot having a first total number of symbols in accordance with selecting the first starting symbol and a second total number of symbols in accordance with selecting the second starting symbol; selecting either a first demodulation reference signal (DM-RS) pattern from a group of DM-RS patterns in accordance with the initial slot having the first total number of symbols or a second DM-RS pattern from the group of DM-RS patterns in accordance with the initial slot having the second total number of symbols; and transmitting, during the COT, sidelink information to a second UE via a sequence of slots, the sequence of slots including the initial slot.

Clause 10. The method of Clause 9, in which: each of the group of DM-RS patterns is associated with a respective set of DM-RSs; each DM-RS of the respective set of DM-RSs is allocated to a respective symbol position of a group symbols positions within the initial slot; and the respective symbol position associated with each DM-RS of the set of DM-RSs is relative to the first starting symbol or the second starting symbol in accordance with selecting the first starting symbol or the second starting symbol.

Clause 11. The method of Clause 10, in which the second DM-RS pattern is the same as the first DM-RS pattern.

Clause 12. The method of Clause 11, further comprising puncturing one or more DM-RSs associated with the second DM-RS pattern based on the respective symbol position of each of the one or more DM-RSs being outside a range of symbol positions associated with the initial slot.

Clause 13. The method of Clause 11, in which the respective set of DM-RSs associated with the first DM-RS pattern include three or more DM-RSs.

Clause 14. The method of any one of Clause 10-13, in which each DM-RS of the respective set of DM-RSs is a physical sidelink control channel (PSCCH) DM-RS or a physical sidelink shared channel (PSSCH) DM-RS.

Clause 15. The method of any one of Clauses 9-14, in which: an initial symbol of the initial slot is an automatic gain control (AGC) symbol; and each remaining symbol of the initial slot is one of a physical sidelink control channel (PSCCH) symbol or a physical sidelink shared channel (PSSCH) symbol.

Clause 16. The method of any one of Clauses 9-15, in which: the first starting symbol is preconfigured as any one of symbols zero to six in the initial slot or set to symbol zero as default; and the second starting symbol is preconfigured as any one of symbols three to seven in the initial slot.

Clause 17. The method of any one of Clauses 9-16, in which the second starting symbol is after the first starting symbol.

Clause 18. The method of any one of Clauses 9-17, in which a total number of symbols allocated for the sidelink information, in the initial slot, from the second starting symbol to a final symbol is greater than or equal to six, inclusive of both the second starting symbol and the final symbol.

Clause 19. The method of any one of Clauses 9-18, in which the initial slot uses a same final symbol regardless of selecting the first starting symbol or the second starting symbol.

Clause 20. An apparatus comprising a processor, memory coupled with the processor, and instructions stored in the memory and operable, when executed by the processor to cause the apparatus to perform any one of Clauses 1 through 8.

Clause 21. An apparatus comprising at least one means for performing any one of Clauses 1 through 8.

Clause 22. A computer program comprising code for causing an apparatus to perform any one of Clauses 1 through 8.

Clause 23. An apparatus comprising a processor, memory coupled with the processor, and instructions stored in the memory and operable, when executed by the processor to cause the apparatus to perform any one of Clauses 9 through 19.

Clause 24. An apparatus comprising at least one means for performing any one of Clauses 9 through 19.

Clause 25. A computer program comprising code for causing an apparatus to perform any one of Clauses 9 through 19.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions, and variations can be made in and to the materials, apparatus, configurations, and methods of use of the devices of the present disclosure without departing from the spirit and scope thereof. In light of this, the scope of the present disclosure should not be limited to that of the particular aspects illustrated and described herein, as they are merely by way of some examples thereof, but rather, should be fully commensurate with that of the claims appended hereafter and their functional equivalents.

What is claimed is:

1. An apparatus at a first user equipment (UE), comprising:
one or more processors; and
one or more memories coupled with the one or more processors and storing processor-executable code that, when executed by the one or more processors, is configured to cause the apparatus to:
perform, in a shared radio frequency band, a listen-before-talk (LBT) procedure for a channel occupancy time (COT);
select a first starting symbol or a second starting symbol for an initial slot based on a timing associated with the LBT procedure indicating a clearance, the initial slot having a first total number of symbols in accordance with selecting the first starting symbol and a second total number of symbols in accordance with selecting the second starting symbol;
select either a first demodulation reference signal (DM-RS) pattern from a group of DM-RS patterns in accordance with the initial slot having the first total number of symbols or a second DM-RS pattern from the group of DM-RS patterns in accordance with the initial slot having the second total number of symbols; and
transmit, during the COT, sidelink information to a second UE via a sequence of slots, the sequence of slots including the initial slot.

2. The apparatus of claim 1, in which:
each of the group of DM-RS patterns is associated with a respective set of DM-RSs;
each DM-RS of the respective set of DM-RSs is allocated to a respective symbol position of a group symbols positions within the initial slot; and
the respective symbol position associated with each DM-RS of the set of DM-RSs is relative to the first starting symbol or the second starting symbol in accordance with selecting the first starting symbol or the second starting symbol.

3. The apparatus of claim 2, in which the second DM-RS pattern is the same as the first DM-RS pattern.

4. The apparatus of claim 3, in which execution of the processor-executable code further causes the apparatus to puncture one or more DM-RSs associated with the second DM-RS pattern based on the respective symbol position of each of the one or more DM-RSs being outside a range of symbol positions associated with the initial slot.

5. The apparatus of claim 3, in which the respective set of DM-RSs associated with the first DM-RS pattern include three or more DM-RSs.

6. The apparatus of claim 2, in which each DM-RS of the respective set of DM-RSs is a physical sidelink control channel (PSCCH) DM-RS or a physical sidelink shared channel (PSSCH) DM-RS.

7. The apparatus of claim 1, in which:
an initial symbol of the initial slot is an automatic gain control (AGC) symbol; and
each remaining symbol of the initial slot is one of a physical sidelink control channel (PSCCH) symbol or a physical sidelink shared channel (PSSCH) symbol.

8. The apparatus of claim 1, in which:
the first starting symbol is preconfigured as any one of symbols zero to six in the initial slot or set to symbol zero as default; and
the second starting symbol is preconfigured as any one of symbols three to seven in the initial slot.

9. The apparatus of claim 8, in which the second starting symbol is after the first starting symbol.

10. The apparatus of claim 1, in which a total number of symbols allocated for the sidelink information, in the initial slot, from the second starting symbol to a final symbol is greater than or equal to six, inclusive of both the second starting symbol and the final symbol.

11. The apparatus of claim 1, in which the initial slot uses a same final symbol regardless of selecting the first starting symbol or the second starting symbol.

12. A method for wireless communication at a first user equipment (UE), comprising:
performing, in a shared radio frequency band, a listen-before-talk (LBT) procedure for a channel occupancy time (COT);
selecting a first starting symbol or a second starting symbol for an initial slot based on a timing associated with the LBT procedure indicating a clearance, the initial slot having a first total number of symbols in accordance with selecting the first starting symbol and a second total number of symbols in accordance with selecting the second starting symbol;
selecting either a first demodulation reference signal (DM-RS) pattern from a group of DM-RS patterns in accordance with the initial slot having the first total number of symbols or a second DM-RS pattern from the group of DM-RS patterns in accordance with the initial slot having the second total number of symbols; and
transmitting, during the COT, sidelink information to a second UE via a sequence of slots, the sequence of slots including the initial slot.

13. The method of claim 12, in which:
each of the group of DM-RS patterns is associated with a respective set of DM-RSs;
each DM-RS of the respective set of DM-RSs is allocated to a respective symbol position of a group symbols positions within the initial slot; and
the respective symbol position associated with each DM-RS of the set of DM-RSs is relative to the first starting symbol or the second starting symbol in accordance with selecting the first starting symbol or the second starting symbol.

14. The method of claim 13, in which the second DM-RS pattern is the same as the first DM-RS pattern.

15. The method of claim 14, further comprising puncturing one or more DM-RSs associated with the second DM-RS pattern based on the respective symbol position of each of the one or more DM-RSs being outside a range of symbol positions associated with the initial slot.

16. The method of claim 14, in which the respective set of DM-RSs associated with the first DM-RS pattern include three or more DM-RSs.

17. The method of claim 13, in which each DM-RS of the respective set of DM-RSs is a physical sidelink control channel (PSCCH) DM-RS or a physical sidelink shared channel (PSSCH) DM-RS.

18. The method of claim 12, in which:
an initial symbol of the initial slot is an automatic gain control (AGC) symbol; and
each remaining symbol of the initial slot is one of a physical sidelink control channel (PSCCH) symbol or a physical sidelink shared channel (PSSCH) symbol.

19. The method of claim 12, in which:
the first starting symbol is preconfigured as any one of symbols zero to six in the initial slot or set to symbol zero as default; and
the second starting symbol is preconfigured as any one of symbols three to seven in the initial slot.

20. The method of claim 19, in which the second starting symbol is after the first starting symbol.
